(19) United States
(12) Patent Application Publication
(10) Pub. No.: US 2021/0308766 A1
(43) Pub. Date: Oct. 7, 2021

(54) ANALYSIS SYSTEM AND METHOD FOR A METAL POWDER JET

(71) Applicants: BEAM, Strasbourg (FR); IREPA LASER, Illkirch Graffenstaden (FR)

(72) Inventors: JONATHAN FRECHARD, ILLKIRCH GRAFFENSTADEN (FR); FRANCOIS SCHEHR, MOTHERN (FR); FELIX BOISSELIER, PLOBSHEIM (FR); DIDIER BOISSELIER, PLOBSHEIM (FR); ERIC BERNARD, STRASBOURG (FR)

(21) Appl. No.: 17/058,949

(22) PCT Filed: May 23, 2019
(86) PCT No.: PCT/FR2019/051182

§ 371 Date: Apr. 7, 2021

(30) Foreign Application Priority Data
May 28, 2018 (FR) 1854498

(51) Int. Cl. B22F 10/34; B22F 12/70; B22F 10/85; B22F 12/53; B22F 12/90; B33Y 50/02

(52) U.S. Cl. CPC B22F 10/34; B22F 12/70; B22F 10/85; B33Y 30/00; B22F 12/90; B33Y 50/02; B22F 12/53

(57) ABSTRACT

Analysis system (310) for a powder jet of an additive manufacturing machine, said powder jet (21) comprising powder and gas, said analysis system (310) comprising a separation device (312), said separation device (312) comprising: —a separator element (326, 327) comprising a circular side wall (328) defining a cylinder and at least one separation wall (330) suitable for separating the inner volume of said separator element (326, 327) into n equal portions that are symmetric with respect to the axis of symmetry of the cylinder, said separator element (326, 327) being suitable for receiving an initial powder jet (21) at the centre of said separator element (326, 327), on said at least one separation wall (330), in order to separate the initial powder jet (21) into n powder jet portions; and —means for detecting the quantity of powder in each powder jet portion.

### FIELD OF THE INVENTION

The present invention relates to the field of additive manufacturing and, more specifically, an analysis system and an analysis method for a metal powder jet.

### PRIOR ART

Nowadays, additive manufacturing is considered as an industrial production technology. In this respect, additive manufacturing is used in numerous industrial sectors such as the aeronautic or medical sectors, which belong to demanding fields. Thus, it is necessary to produce parts of very high quality for the final client. Consequently, any drift in the manufacturing method must be identified rapidly. In addition, the final client is often interested in the manufacturing history of the part, which makes it possible to ensure traceability of the manufacturing method.

In the prior art, the method for depositing material under concentrated energy is based on the principle of depositing metal powders in the molten state on a solid substrate.

Indeed, the initial principle consists in using a tool for sending metal powder in solid form, with a defined particle size, typically of the order of 45 to 90 μm, into a power beam such as a laser beam or an electron beam. On traversing the laser beam, the powder is heated and melts, and immediately reaches the substrate in the molten state to form a layer. The tool being displaced, it is thus possible to create metal beads on the substrate. The layers are next superimposed in such a way as to create volume parts. Metal powder is the basis of any construction carried out using additive manufacturing by means of this method and, consequently, proper management of the powder jet and the tool enabling its shaping, that is to say the nozzle, is indispensable.

The powder, of very fine particle size, is sent in the form of a jet composed: of a transport gas (called carrier gas), and particles of metal powder. This jet makes it possible to carry the powder up to the laser beam. The flow rate of gas is expressed in litres/minutes and the flow rate of powder in grammes/minutes.

The powder jet comes from a powder distributor and travels in a tube up to the depositing tool, as near as possible to the laser beam, into which it is injected. The mechanical element through which the powder jet exits is called a nozzle. The metal powder is deposited on the substrate, several millimetres distant from the nozzle. The latter has the role of guiding in a properly managed manner the powder jet comprising the carrier gas in order that said powder jet reaches the laser beam in an optimal manner. The nozzle is composed of several mechanical parts, of which concentric cones, which have the aim of guiding the powder. The guiding of the powder jet depends on two cones: the outer cone and the intermediate cone.

The powder is thus directed into the laser beam by a jet of annular conical shape. It is as though “focused” in the laser beam, which lies at the centre of this conical jet.

In order to guarantee the reliability of the method, it is necessary to properly manage the powder jet. This proper management notably necessitates control of the geometry of the powder jet along its axis of propagation. Indeed, the powder jet is of conical shape, and it is necessary that the distribution of powder along its circumference is homogeneous. The progression of the powder jet between the cones gives it an annular shape, until approaching a convergence zone at the nozzle outlet, which will be the working zone.

The relative positioning of the two cones is however crucial because the behaviour of the powder jet depends thereon. The fact that the cones are coaxial is particularly important because this influences the distribution of powder in the jet. Yet, the relative positioning of the cones is carried out mechanically and, for various reasons, the cones may not be coaxial. Consequently, the behaviour of the powder jet is modified and the distribution of the powder jet may become asymmetric.

This asymmetry has repercussions on the additive manufacturing method and may bring about construction defects on the parts.

Other reasons may be behind a disruption of the powder jet. Depending on the drift of the method encountered, it is easy to be able to suspect an anomaly at the level of the powder jet. It is also indispensable to be able to control the powder jet, and to quantify this drift.

Few solutions exist on the market which make it possible to measure the flow rate of a powder jet and to analyse the behaviour of the powder in a gaseous flow. Indeed, the problem and the application are not very widespread. In addition, the measurement is of mixed aspect because the powder jet is composed of gas and solid metal powder.

At present, different system developments have the aim of analysing uniquely the distribution of the powder in the jet, and do so in different ways. Most concern the use of vision and image analysis. Thus, existing solutions use control by a camera and lighting, which is not recommended on account of the reflection of the illumination light caused by the powder. However, it should be noted that these devices involve often complex and costly technologies, both from a development point of view and from the point of view of implementation on existing equipment. Works on the use of camera and image analysis have been undertaken, but it remains however complex to quantify the distribution of the powder in the jet, in three dimensions.

It proves necessary to propose a powder jet analysis system that overcomes the aforementioned drawbacks. Notably, it proves necessary to propose an analysis system and method that make it possible to obtain a quantified value of the distribution of the metal powder in three dimensions, that is to say in planes perpendicular to the axis of progression of the jet, and which does so at different positions along the axis of propagation of the powder jet and to be able to measure in a precise manner the flow rate of powder and the homogeneity of said powder jet.

### SUMMARY OF THE INVENTION

According to a first aspect, the object of the invention relates to an analysis system for a powder jet of an additive manufacturing machine, said powder jet comprising powder and gas, said analysis system comprising a separation device, said separation device comprising:
a separating element comprising a circular lateral wall defining a cylinder and at least one separation wall suited to separating the inner volume of said separating element into n equal portions symmetrical with respect to the axis of symmetry of the cylinder, said separating element being suited to receiving an initial powder jet at the centre of said separating element, on said at least one separation wall in order to separate the initial powder jet into n portions of powder jet;
means for detecting the quantity of powder in each portion of powder jet.

In a preferred manner, said means for detecting the quantity of powder in each portion of powder jet comprise:
an expansion chamber for separating the gas from the powder in each portion of powder jet;
a storage chamber for storing the powder of each portion of powder jet;
said at least one separation wall, the circular wall and the expansion chamber forming n conduits for guiding each portion of powder jet to the storage chamber suited to containing separately the quantity of powder coming from each conduit.

In a preferred manner, the storage chamber is provided with a storage tube for each conduit, each storage tube being connected to a valve for closing off the conduit.

In a preferred manner, the analysis system comprises an opening device to make it possible to open the valves.

In a preferred manner, the opening device comprises a number n of adjustable cams.

In a preferred manner, the expansion chamber comprises a circumferential chicane to allow the gas to escape.

In a preferred manner, the expansion chamber has a cylindrical end and the storage chamber has a linear end.

In a preferred manner, the analysis system comprises a weighing device suited to weighing the quantity of powder coming from each conduit.

In a preferred manner, the analysis system comprises a suction device to suck up the quantity of powder on the weighing device.

In a preferred manner, the separation device is produced by stereolithography.

According to a second aspect, the object of the invention relates to a powder jet analysis method, wherein the powder jet is emitted from the nozzle of an additive manufacturing machine on an analysis system described above and comprises the following steps:
emission of the powder jet comprising powder and gas;
separation of the powder jet by said at least one separation wall of the separating element into n portions of powder jet;
detection of the quantity of powder in each portion of powder jet.

### BRIEF DESCRIPTION OF THE DRAWINGS

The aim, objects and characteristics of the invention will become clearer on reading the description that follows made with reference to the drawings in which:

FIG. 1 shows according to an exploded view a deposition nozzle according to the prior art,

FIG. 2 shows according to a sectional view and schematically the deposition nozzle of FIG. 1, in the absence of the nozzle body and in the presence of the carrier gas and the secondary gas,

FIG. 3 shows according to a perspective view the device for detecting the laser beam, according to an embodiment of the invention,

FIG. 4 shows according to a perspective view the upper part of the device for detecting the laser beam according to FIG. 3,

FIG. 5 shows the first element of the device for detecting the laser beam according to FIG. 4,

FIG. 6 shows the second element of the device for detecting the laser beam according to FIG. 4,

FIG. 7 shows according to a partial sectional view the device for detecting the laser beam according to FIG. 4,

FIG. 8 shows schematically and according to a sectional view the device for detecting the laser beam according to an embodiment of the invention,

FIG. 9a shows schematically a cone centring device, according to an embodiment of the invention,

FIG. 9b shows an image of underneath the deposition nozzle,

FIG. 9c shows a diagram of the image of FIG. 9b,

FIG. 10a shows according to a perspective view the cone centring device according to an embodiment of the invention,

FIG. 10b shows according to a partial sectional view the cone centring device according to FIG. 10a,

FIG. 11 represents according to a perspective view a powder jet analysis system according to an embodiment of the invention;

FIG. 12 represents according to another perspective view a powder jet analysis system in the absence of the weighing device, according to an embodiment of the invention;

FIG. 13 represents schematically according to a perspective view a separating element and the deposition nozzle containing four portions, according to an embodiment of the invention,

FIG. 14 represents according to a perspective view a separating element containing six portions, according to another embodiment of the invention,

FIG. 15 represents according to a sectional view a separation device according to an embodiment of the invention,

FIG. 16 shows according to a perspective view the separation device of FIG. 5,

FIG. 17 shows schematically a sectional view of a separation device according to an embodiment of the invention,

FIG. 18 shows according to a perspective view an opening system according to an embodiment of the invention,

FIG. 19 shows according to an exploded view a part of the opening system according to an embodiment of the invention,

FIG. 20 shows according to a partial sectional view the interaction between the valves and the opening device according to an embodiment of the invention,

FIG. 21 shows according to a perspective view a funnel according to an embodiment of the invention,

FIG. 22 shows according to a perspective view a suction device according to an embodiment of the invention,

FIGS. 23a, 23b and 23c represent according to a front view a separating element comprising two portions and located respectively at three different heights according to an embodiment of the invention.

### DETAILED DESCRIPTION OF AN EMBODIMENT

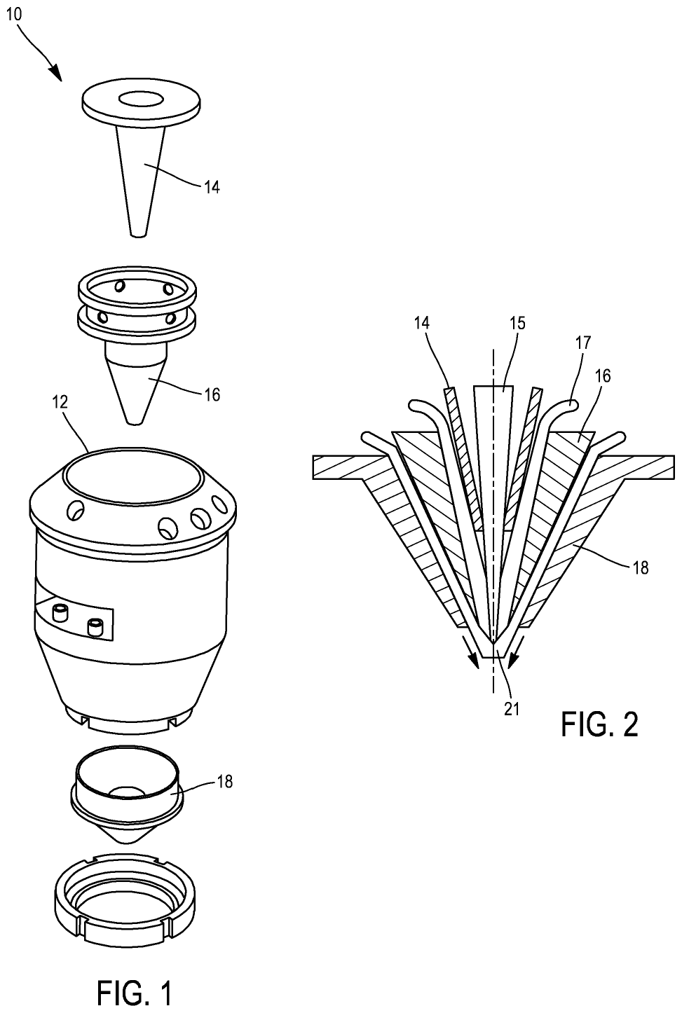

The present invention relates to the DED (Directed Energy Deposition) method, an additive manufacturing method which notably consists in constructing a dense part on a substrate, layer after layer, by the fusion of metal powders injected through a laser beam. This method is applied by means of a machine comprising a nozzle 10 or deposition nozzle. FIG. 1 shows an exploded view of a nozzle 10 comprising a nozzle body 12, a first cone or inner cone 14, a second cone or intermediate cone 16 and a third cone or outer cone 18. The first cone 14, the second cone 16 and the third cone 18 are made of copper and are arranged in a concentric manner.

A laser beam 15 is emitted by a laser. An optic fibre makes it possible to transport the laser beam up to an optical head (not shown) on which is fixed the nozzle 10. Next, the laser beam traverses the nozzle up to the substrate (not shown).

As shown in FIG. 2, schematically, the first cone 14 is traversed by the laser beam 15 and is not visible from the outside of the nozzle 10. The second cone 16 is traversed by a gas 17 called secondary gas such as argon enabling the shaping of the powder jet in order to focus the flow of powder. The end of the second cone is visible from the outside of the nozzle. The third cone 18 makes it possible to bring the powder to the level of the molten bath on the substrate by a carrier gas 21 such as argon.

Detection of the Laser Beam

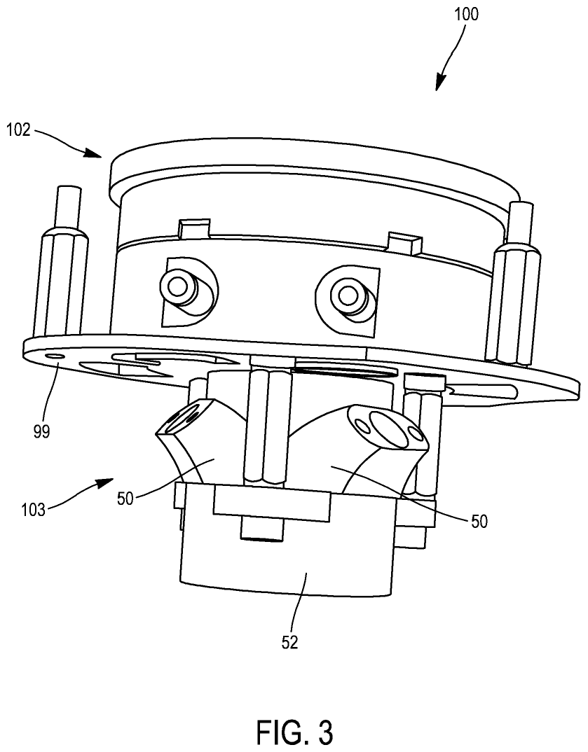

FIG. 3 shows a device 100 for detecting the laser beam 15 which comprises an upper part 102 and a lower part 103. The detection device 100 makes it possible to determine with precision the position of the laser beam with respect to said detection device 100.

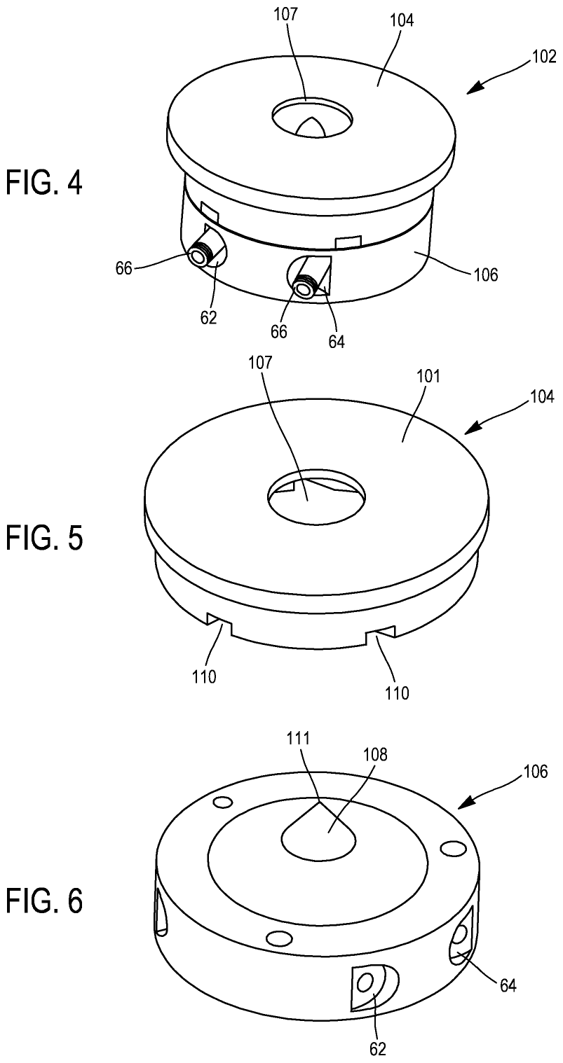

The upper part 102 shown in FIG. 4 comprises a first element 104 and a second element 106 fixed on a metal plate 99. The first and the second element 104, 106 are made of copper in order to avoid overheating the material during the emission of a laser beam on the detection device 100. Indeed, the copper material is of red colour, just like the laser beam. The copper thus operates as a mirror and absorbs very little energy. Consequently, the copper heats up very little compared to other materials.

As shown in FIG. 5, the first element 104 is of circular shape with a defined height and comprises a circular central opening 107 in an upper surface 101 of the upper part 102. The first element 104 also comprises notches or vents 110. These notches 110 are each oriented at 45° with respect to the axis of the laser beam. FIG. 5 shows two notches 110 intended to improve the cooling of the detection device 100. Indeed, when the laser beam scans the scanning zone or surface 108, described hereafter, of the detection device 100, the nozzle also emits a jet of secondary gas 17. Thanks to the vents 110, the secondary gas 17 can circulate freely between the conical surfaces then escape through the vents 110. The detection device 100 is then cooled by convection. The defined angle of 45° (degrees) makes it possible to avoid that reflections of the laser beam come out of the detection device 100 to damage the environment of said detection device 100.

The second element 106 is shown in FIG. 6 and comprises a circular shape of a defined thickness. At the centre of the second element 106 is found a point shaped surface 108 pierced by a circular opening or calibrated hole 111 of a diameter of around some 800 μm (micrometres) to 50 μm (micrometres). This diameter corresponds approximately to the diameter of the laser beam. The calibrated hole 111 is situated at the centre of the circular central opening 107.

The second element 106 also comprises a U-shaped cooling channel of which the inlet 62 and outlet 64 orifices for the cooling fluid, for example water, are visible in FIGS. 4 and 6. FIG. 4 also shows the rapid attachment piping connections 66.

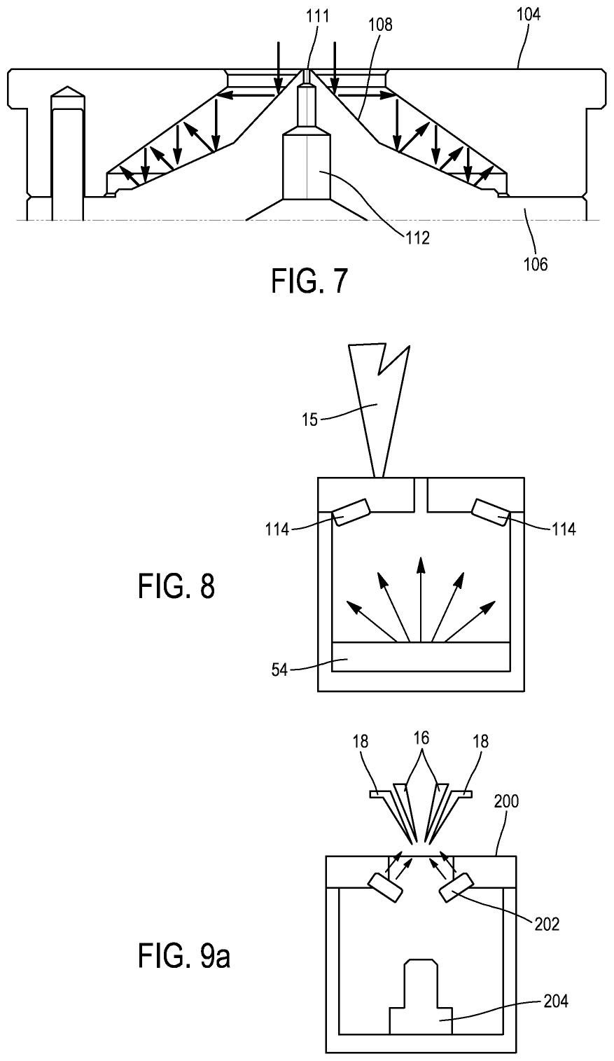

As shown in the partial sectional view of FIG. 7, the shapes of the first and the second element 104, 106 are adapted so that the reflections of the laser beam are infinite between the two inner conical surfaces as shown in FIG. 7 with arrows. Thus, the energy of the laser beam is dissipated as it propagates, and harmful reflections on the nozzle 10 are avoided. The surface 108 or scanning zone is also shown in FIG. 7.

As shown in FIG. 3, the detection device 100 also comprises a lower part 103 comprising three compartments 50 each comprising a sensor such as a photodiode 114 (not visible). Only two compartments 50 are shown in FIG. 3. The lower part 103 also comprises a receptacle 52 comprising an absorbing element such as a graphite martyr plate 54 (not visible) in the bottom of the receptacle 52. Thus, the laser beam passes through the calibrated hole 111 and strikes the graphite martyr plate 54. A part of the energy or residual energy is reflected by the graphite martyr plate 54. FIG. 8 shows in a schematic diagram and according to a sectional view two photodiodes 114 located under the second element 106. The photodiodes 114 are arranged facing the graphite martyr plate 54 to be able to capture or detect or measure the residual energy of the laser beam 15 reflected by the graphite martyr plate 54. The model of each photodiode 114 is for example the PIN-5DPI of the Osi Optoelectronics brand. The photodiodes 114 are used for example in photovoltaic mode. The photodiodes 114 may also be used in blocking mode. Each photodiode 114 is coupled within an electronic circuit for example with a transimpedance amplification mounting in order to amplify the weak current generated and to convert it into a voltage signal more easily readable by a micro-controller.

The laser beam 15 scans the scanning zone or surface 108, visible at the centre of the circular central opening 107 around the calibrated hole 111, and the calibrated hole 111 itself, making for example back and forth movements on this surface 108 in such a way as to scan the totality of the surface 108. When the laser beam is positioned exactly above and at the centre of the calibrated hole 111, the energy of the laser beam that reaches the graphite martyr plate is maximum. Thus, the aim of the detection module is to seek the moment where the laser beam 15 and the calibrated hole 111 are perfectly aligned. In so far as the position of the calibrated hole 111 is known, it is possible to deduce therefrom the position of the laser beam 15. The residual energy of the laser beam 15 which is emitted by the graphite martyr plate 54 is measured by the photodiodes 114. When this energy is maximum, this signifies that the laser beam 15 is aligned with the calibrated hole 111.

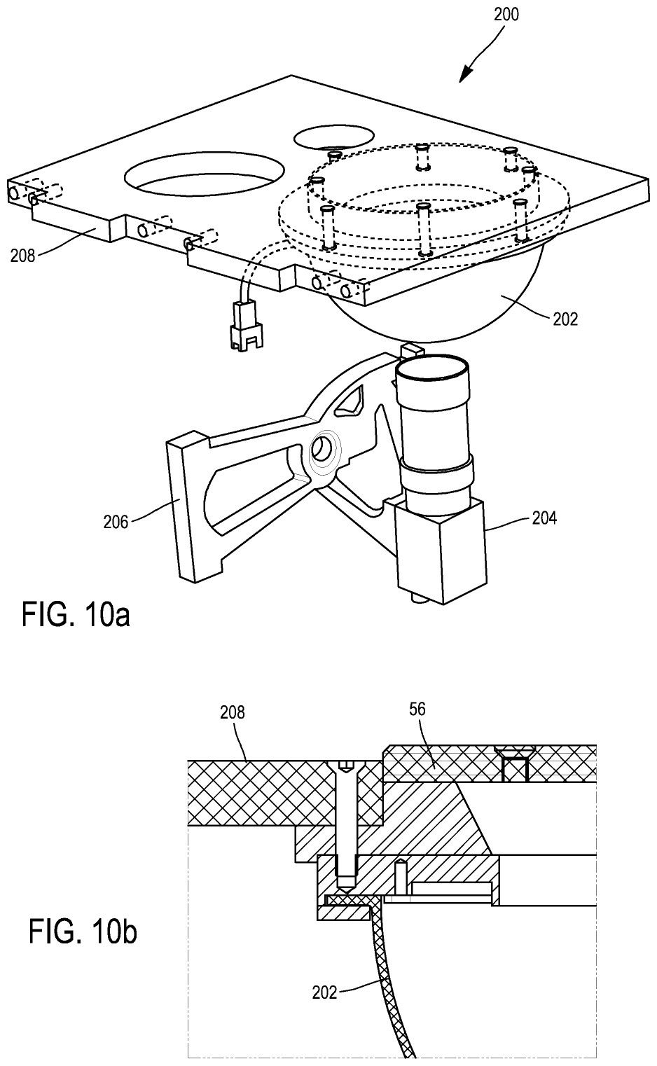

The device for detecting the laser beam 100 also comprises additional structural means. These additional structural means comprise, for example, a shoulder on the first element 104 enabling a short centring on a base plate 208 shown in FIG. 10a in order to enable the putting in position of the device for detecting the laser beam 100 in an exact manner and to know the position of the calibrated hole 111 in a precise manner.

The device 100 for detecting the laser beam also comprises fixation means such as spacers with screws and threadings in the base plate 208 to enable the detection device 100 to be maintained in position. The device 100 for detecting the laser beam must be positioned in a very precise manner in order to know the exact position of the calibrated hole 111 in order to deduce therefrom later the position of the laser beam when it is aligned with the calibrated hole 111.

During the use of the device 100 for detecting the laser beam 15, the detection method comprises the steps described hereafter. The nozzle 10 emits a laser beam of a power of around, for example, 200 to 300 W (Watts) or preferably 500 to 700 W (Watts) that covers the surface of the pierced point 108 visible through the circular central opening 107 of the upper part 104. Thus, the scanning zone 108 is situated below the circular central opening 107. The laser beam 15 is going to scan the surface 108 while occupying several positions. When the laser beam 15 occupies positions situated outside the calibrated hole, the energy of the laser beam is diffused in the copper through infinite reflections visible by arrows in FIG. 7. The photodiodes then provide a zero signal. When the laser beam occupies positions situated above the hole in a non-centred manner, the energy of the laser beam is transmitted via the circular hole 111 to the graphite martyr plate 54. The photodiodes 114 capture a quantity of residual energy and then produce a non-zero electrical signal. When the laser beam passes totally above the calibrated hole 111 and is aligned with the calibrated hole 111, all of the energy of the laser beam passes through the calibrated hole 111 and touches the graphite martyr plate 54 which absorbs the major part thereof. The residual energy of the laser beam is measured by the photodiodes 114 then filtered by means of electronic circuits. In this situation, the residual energy captured by the photodiodes is maximum. For all of the positions occupied by the laser beam, an electrical signal having a Gaussian shape is produced. The position of the laser beam aligned with the calibrated hole 111 corresponds to the peak of the Gaussian. Next, the log of machine positions is used. This is a file provided by the additive manufacturing machine and which records the positions of the manufacturing head that emits the laser beam and thus the nozzle in order to know the exact position of said manufacturing head at a time t. This file generates an input around every 15 ms (milliseconds). Thus, the log of positions and the signal obtained by the photodiodes are synchronised or time matched to obtain the X and Y coordinates corresponding to the focal point, that is to say to the centre of the laser beam relative to the position of the device 100 for detecting the laser beam.

Thus, the method for detecting the position of the laser beam comprises the following steps for the nozzle 10 being displaced according to positions defined in a frame of reference (0,x,y) above the surface 108 containing the calibrated hole 111:
emission of a laser beam of a determined power and scanning of the surface 108 that is to say around the calibrated hole 111 and in the calibrated hole 111 such that the energy of the laser beam is dissipated between the first and the second element 104, 106;
measurement and filtering of the signal obtained by means of photodiodes 114 said signal representing the quantity of luminous energy of the laser that passes through the calibrated hole 111 and which is reflected by the graphite martyr plate 54;
synchronisation over a time scale or time matching of the filtered electrical signal with the position data of the deposition nozzle 10 or the manufacturing head of the additive manufacturing machine;
obtaining, in the frame of reference of the deposition nozzle 10 or the manufacturing head, the position for which the focal point of the laser beam is exactly above the calibrated hole and is thus aligned with the calibrated hole 111, that is to say for a maximum filtered electrical signal value.

Thus, the device 100 for detecting the laser beam 15 makes it possible to determine the position of the focal point of the laser beam 15 with a precision of the order of 50 μm (micrometres) for a laser beam power ranging from around 1 to 1000 W (Watts) or even above 1500 W.

Centring and State of the Cones

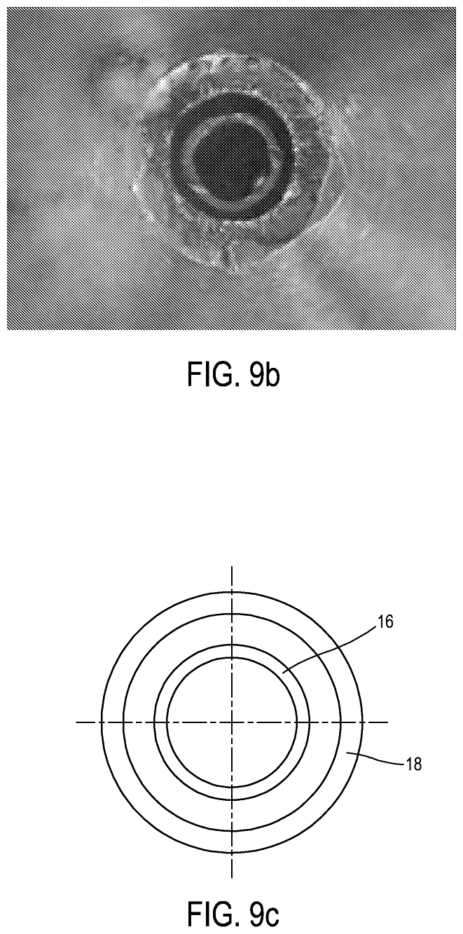

FIG. 9a shows schematically, and according to a schematic diagram, a cone centring device 200. The cone centring device 200 comprises a lighting device 202 and a camera 204.

The lighting device 202 illuminates according to the colour red. Indeed, the copper cones of the nozzle being of red colour, this illumination is the most suitable. The lighting device 202 comprises a luminous dome for example of the Effilux brand and for example of 100 mm (millimetres) diameter which comprises a hole on the lower surface of said dome.

The camera 204 is of very high definition and has a black and white sensor. Thus, the camera 204 is for example of Basler acA2440-20 gm brand and has for example a resolution of 2448×2048. The focal length is 35 mm (millimetres) for example. The lens chosen is, for example, the Fujinon HF35HA1B.

As shown in FIG. 10a, the cone centring device 200 also comprises a support 206 for the camera 204.

The cone centring device 200 comprises a base plate 208 made of polycarbonate below which are situated the lighting device 202 and the camera 204. The base plate comprises three piercings or three holes in order to integrate the device 100 for detecting the laser beam, the cone centring device 200 and the powder jet analysis system described hereafter. As shown in FIG. 10b, the camera 204 is protected, by a window 56 made of polycarbonate, from dust and residual powder which could be introduced into the cone centring device 200 through the hole at the bottom of the lighting device 202.

During the use of the cone centring device 200, the centre of the laser beam, such as measured with the device for detecting the laser beam, must be aligned with a known frame of reference of the camera 204, for example the centre of an image taken by the camera 204 as shown in FIG. 9b.

All of the calculation steps carried out within the context of the operation of the cone centring device 200 are performed by industrial viewing software. The camera acquires images relative to the end of the nozzle and which correspond to the concentric circles shown in FIG. 9c.

The cone centring method 200 firstly comprises a step of calculating the centres associated with the different visible diameters of the outer 18 and intermediate 16 cones shown in FIG. 9c. Next, the method comprises a step of calculating the offset along the horizontal axis OX and the vertical axis OY of the laser beam as well as that of the different centres of circles corresponding to the cones and calculated in the preceding step.

If these parameters have correct values compared to determined reference values, the method continues with the following steps. The method thus comprises a step of calculating the inner and outer diameters of the different inner and intermediate cones by the least squares technique. The maximum allowed misalignment around the laser beam is of the order of 50 μm (micrometres). Then, the method comprises a step of detecting and measuring deformation, obstruction, lack of material type defects on the two visible cones by means of image recognition software.

If a defect is detected by means of image recognition software, the method continues with an intervention of the user to carry out the necessary operation on the nozzle such as the realignment or the cleaning of the cones, or the complete change of the cones if they are damaged.

If no defect is detected, the method continues with a step of saving the measured data in a database.

Thus, the cone centring method comprises the following steps:
placement of the laser beam with a position measured with the module for detecting the laser beam in the defined frame of reference, that is to say the centre of the image taken by the camera
launching the image acquisition
detecting the presence of defects on the cones and intervention of the user for a change of cones if necessary
measuring the diameters of the outer and intermediate cones
comparing with reference values and intervention of the user for a change of cones if necessary
calculating the centres associated with said diameters
calculating the offset along the horizontal axis OX and along the vertical axis OY of the cones with respect to the laser beam, that is to say with respect to the centre of the camera
depending on the results, intervention of the user on the nozzle for a realignment of the cones.

Thus, the cone centring device 200 makes it possible to verify that the cones are concentric around the laser beam, but also that they are in good condition that is to say round and clean. The cone centring device 200 also makes it possible to retain a history of the state of the cones as manufacturing proceeds.

Analysis of the Powder Jet

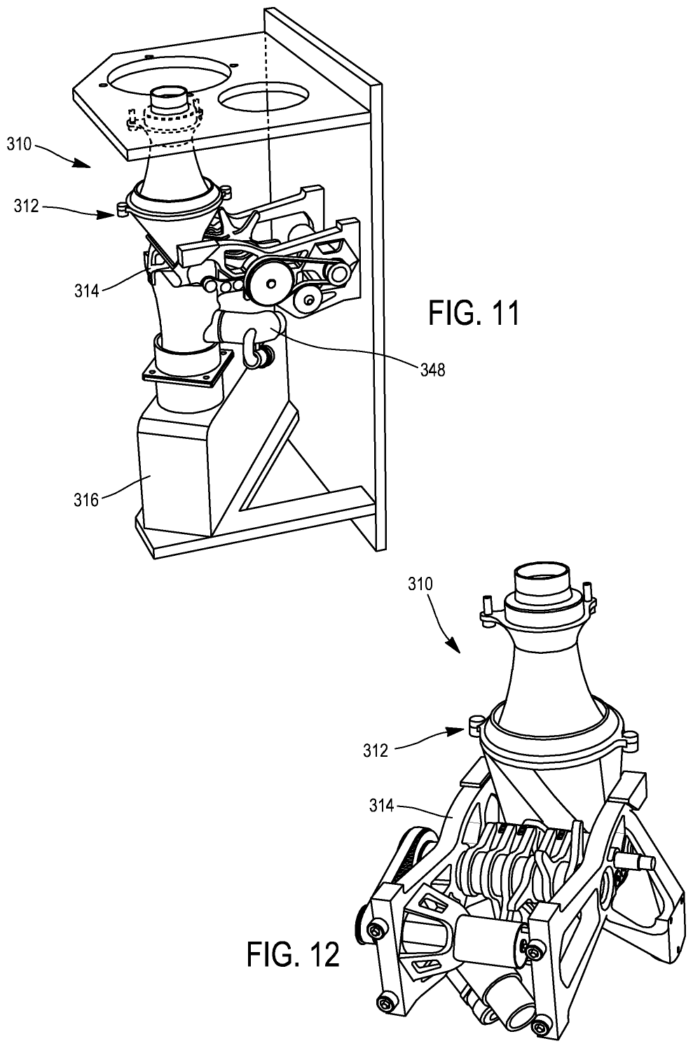

FIGS. 11 and 12 show a powder jet analysis system 310 according to the invention. The analysis system 310 comprises a separation device 312, an opening device 314, a weighing device or balance 316 and a suction device 348.

The analysis system according to the invention is suited to operating with the device 100 for detecting the laser beam and the cone centring device 200.

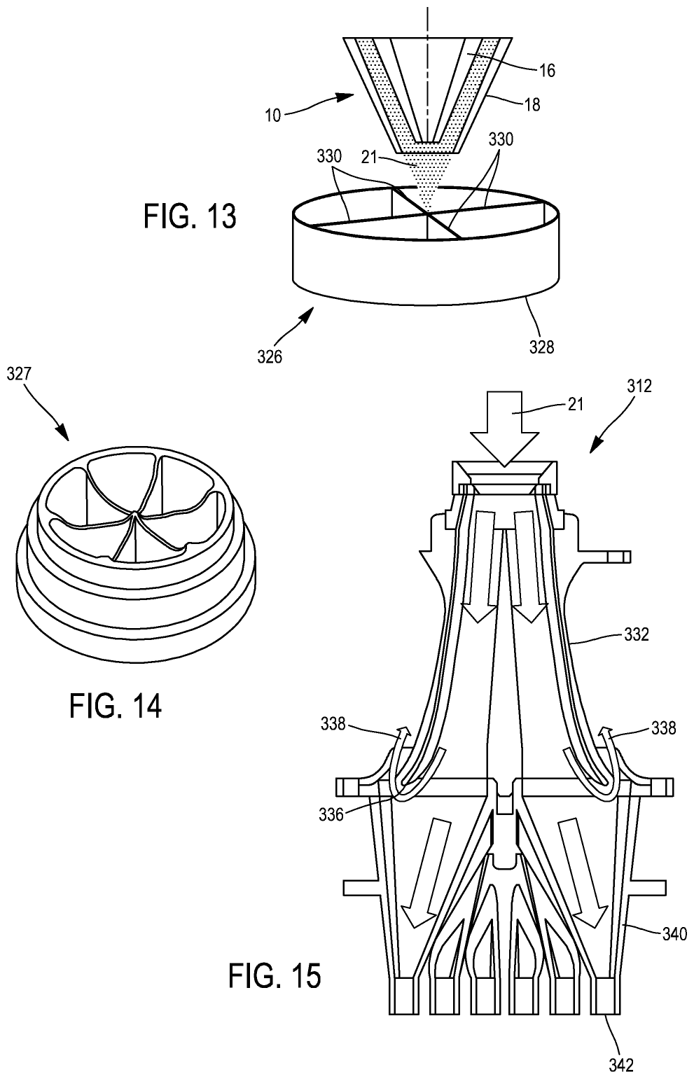

The analysis system 310 according to the invention is also suited to operating with a deposition nozzle integrated in an additive manufacturing machine such as known in the prior art and shown in FIGS. 2 and 13. The deposition nozzle 10 notably comprises the intermediate cone 16 and the outer cone 18. The powder jet 21 contains metal powder and a carrier gas. The powder jet 21 takes the form of a jet through intermediate 16 and outer 18 cones. In the context of the present invention, the initial or incident powder jet 21 has a diameter at the cone outlet of around 10 mm and a focal distance from the outlet of the outer cone of around 5 mm.

As shown in FIG. 13, according to a schematic diagram, the separation device 312 comprises a separating element 326 provided with a circular lateral wall 328 which defines a cylinder. The diameter of the separating element 326 is of the order of several centimetres. The separating element 326 comprises one or more separation walls 330 which are arranged in a symmetrical manner with respect to the central axis of symmetry of the cylinder. The separation walls 330 thus divide the inner volume of the separating element 326 into a number of portions or honeycombs each having the same volume. In FIG. 13, the four separation walls 330 divide the volume of the separating element 326 into four portions of equal volume. The number of separation walls 330 can vary to obtain a number of portions of equal volume comprised between 2 and 10 for example. The presence of a large number of portions of equal volume makes it possible to better verify the homogeneity of the powder jet. The length of a separation wall may be the length of the radius of the separating element or the length of the diameter of the separating element.

As shown in FIG. 14, according to another alternative, the separating element 327 may contain six separation walls to obtain six portions of equal volume. The thickness of the separation walls 330 must be as small as possible, and is of the order of 0.1 mm for example, in order to disrupt as little as possible the flow of the powder jet 21 and to achieve a clear separation of the powder jet.

The separating element 326, 327 may be made of metal to be able to withstand erosion by the powder jet. The separating element 326 may be produced by SLM (Selective Laser Melting) additive manufacturing using for example a 316L stainless steel or a tool steel of H13 type (X40CrMoV5-1). The diameter of the separating element 326, 327 is around 3 cm (centimetres).

Thus, as shown in FIG. 13, the initial powder jet 21 that falls on the separating element 326 is divided through the portions of said separating element. The separating element 326 of FIG. 13 makes it possible to divide or separate the powder jet into four portions of powder jet and the separating element 327 of FIG. 14 makes it possible to divide or separate the powder jet into six portions of powder jet.

The separation device 312 comprises means for detecting the quantity of powder in each portion of powder jet. These means comprise on the one hand an expansion chamber 332 described below and a storage chamber 340 described below.

Thus, as shown in FIG. 15, the separation device 312 also comprises a first receptacle or expansion chamber 332 having a cylindrical end. Indeed, the first receptacle 332 is a zone intended to serve as expansion chamber for the carrier gas contained in the powder jet 21 and allows it to escape through a circumferential chicane 336 as shown by the arrows 338 while enabling the powder to flow into the second receptacle 340.

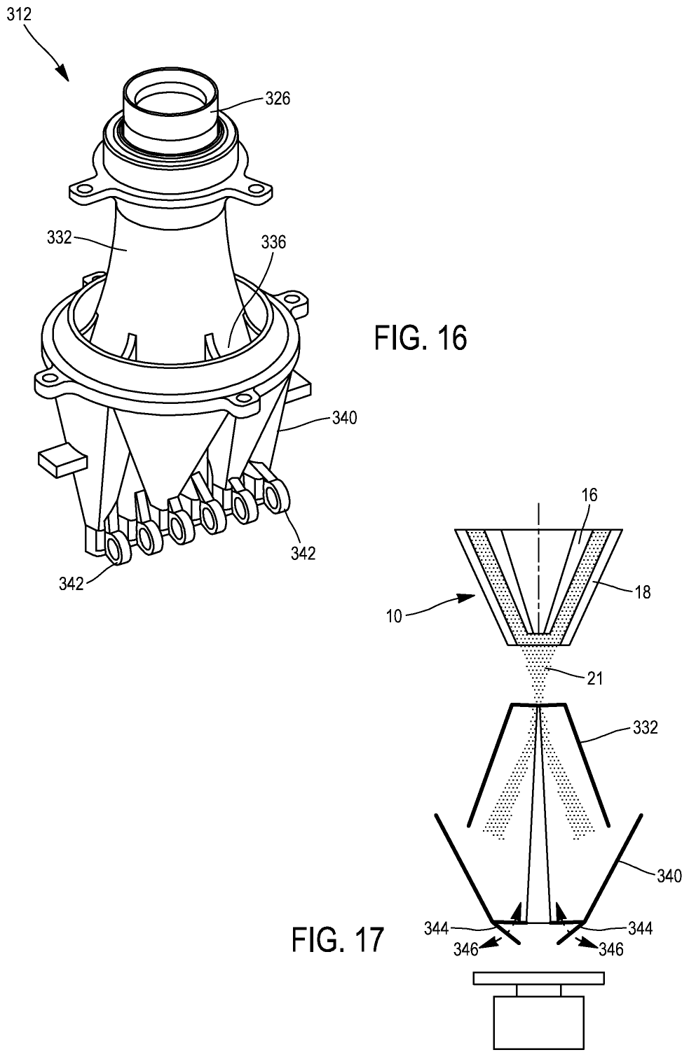

The second receptacle or storage chamber 340 shown in FIG. 15 comprises storage tubes 342 for storing the powder that has flowed. The storage chamber 340 has a linear end 20 enabling the fixation of the opening device described hereafter as shown in FIG. 16.

FIG. 16 shows a perspective view of the separation device 312 of FIG. 15.

The structure formed by the separating element 327, that is to say by the circular lateral wall 328 and the separation walls 330, as well as the expansion chamber 332 form conduits where the portions of powder jet flow, each portion of powder jet flowing in a determined respective conduit 30. The storage tubes 342 form the end of the conduits.

Each storage tube 342 comprises a valve 344 to make it possible to open and to close each conduit. The opening and closing movement of the valves 344 is represented in FIG. 17, according to a schematic diagram, by two-directional arrows 346. Each valve 344 comprises a return spring 60.

The valves 344 operate with an opening device 314.

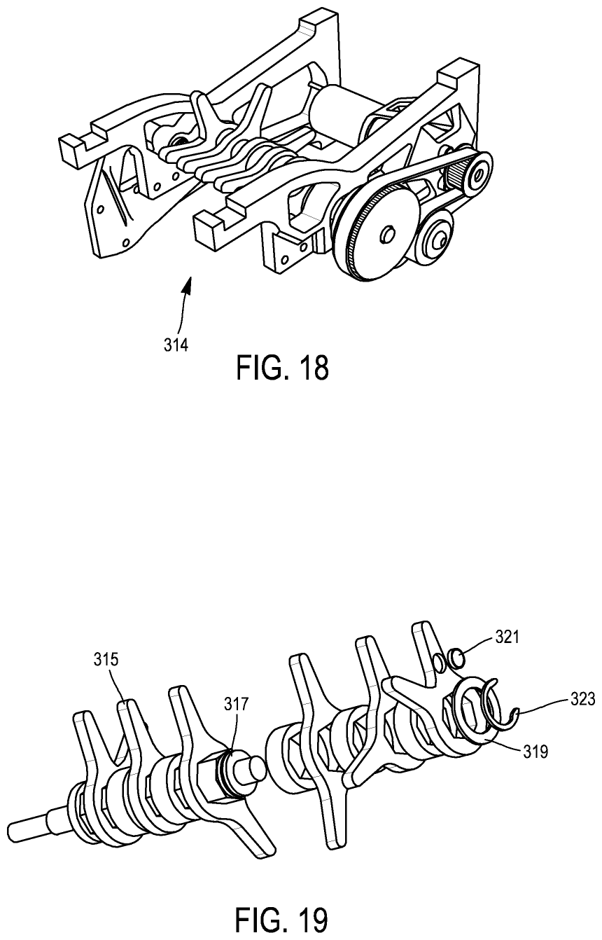

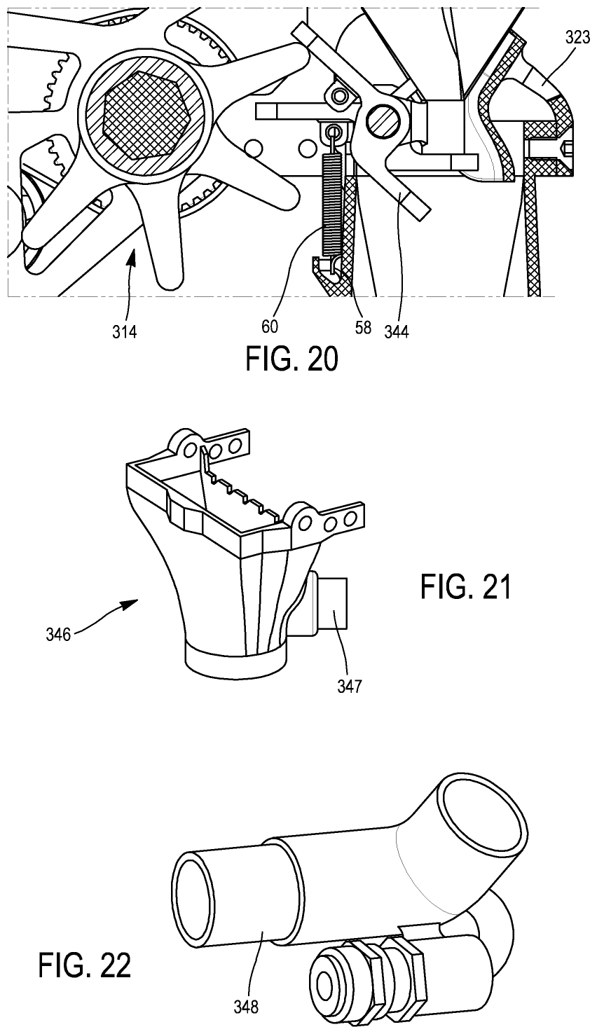

The valve opening device 314 is automated by means of adjustable cams for example as shown in FIG. 18. Each valve 344 may thus be controlled independently of each other. The number of cams is equal to the number of valves, itself equal to the number of portions of the separating element 327. Indeed, as shown in FIG. 19, the opening device 314 comprises six cams 315 mounted in abutment against the shoulder on an axle 317 with heptagonal section, spaced apart by spacers and blocked by an elastic ring 323. The cam 315 situated at the end of the axle 317 comprises a magnet 321. The axle 317 is mounted on PTFE (polytetrafluoroethylene) bearings and is driven by a motor with a pulley and belt system having a reduction ratio of two to reduce the speed of rotation as much as possible. The opening device 314 comprises a sensor with flexible blade or with reed effect which is positioned laterally in order to detect the instant where the cam situated at the end of the axle 317 passes in front of the reed sensor. FIG. 20 shows a sectional view of the opening device 314 with the valves 344. As shown in FIG. 20, a funnel 346 described hereafter is associated with a skirt 323 in order to avoid that a quantity of powder is ejected outside of the funnel 346 when the valves close under the effect of the return spring 60. The skirt 323 makes it possible to redirect to the funnel the grains of powder ejected towards the front of the separation device. The length of the analysis system from the separating element 327 up to the funnel is around 20 cm (centimetres).

According to the embodiment of the present invention, the separation device comprises six valves 344.

As shown in FIG. 16, the expansion chamber 332 and the storage chamber 340 also form the conduits for guiding the powder to the valves 344. In order to enable the powder to slide in the conduits with a minimum of friction, the material used must be smooth and preferably conductive to avoid phenomena of static electricity. Thus, the assembly formed by the expansion chamber 332, the storage chamber 340 and the valves 344 is produced by stereolithography. This 3D printing technique makes it possible to use a transparent material, TuskXC2700T which has mechanical characteristics similar to ABS (acrylonitrile butadiene styrene) and PBT (polybutylene terephthalate). Indeed, a part made of ABS may be replaced by a part made of Tusk of same geometry in a mechanical system without disrupting the operation of said mechanical system.

The analysis system 310 also comprises a funnel 346 shown in FIG. 21. Thus, during the opening of the valves 344, the powder can escape towards the funnel 346. The funnel 346 comprises a coaxial pipe 347 at the outlet of the funnel in order to be able to suck up the powder as indicated hereafter. As shown in FIG. 20, the funnel 346 also comprises maintaining teats 58 for the return springs 60 of the opening device 314 and a reinforcement to stiffen the maintaining teats 58. The funnel 346 also comprises different fixation tabs and tapped holes and the axis passage enabling the positioning of the funnel with respect to the separation device 312 and the valves 344.

The analysis system 310 also comprises a weighing device or balance 316 shown in FIG. 11. Thus, the shape of the funnel 346 makes it possible to guide the powder to the balance 316 to determine the weight of powder that has flowed in a determined conduit.

The analysis system also comprises a suction device 348 shown in FIGS. 11 and 22 and capable of evacuating the powder present on the balance 316, after the measurements. The suction device 348 comprises a one-piece Venturi suction tube shown in FIG. 22 into which argon is injected to carry out the sucking up of the powder.

The analysis system may be assembled within a box such as a casing (not shown).

While in operation, the analysis system 310 is placed in the working enclosure of an additive manufacturing machine according to the prior art. The analysis system 310 must be within range of the nozzle 10, which is movable. More specifically, the nozzle 10 must be situated above the analysis system 310, in a centred manner. Thus, the analysis system 310 is suited to operating with the device for detecting the laser beam 100 and the cone centring device 200 in a manner prior to the operation of said analysis system. Thus, before the start of the analysis of the metal powder jet, the laser beam is situated above the analysis system in a centred manner with the cones also centred. The operation of the analysis system described below then makes it possible to determine if the centring of the cones is satisfactory to obtain a homogeneous powder jet.

During an analysis, the nozzle 10 is positioned above the analysis system, and above the centre of the separating element 326, as shown in FIG. 13 which represents a schematic diagram. The initial powder jet 21 coming from the nozzle 10 then penetrates into the analysis system 310 through the upper part of the separating element 326 which has the role of dividing or separating the initial powder jet into a finite number of portions of powder jet. The initial powder jet 21 pours out for a determined duration.

When the initial powder jet 21 has been divided, each portion of powder jet continues its trajectory in a specific conduit, with determined dimensional characteristics to favour a flow without turbulence. In each conduit, the portion of powder jet covers the expansion chamber 332 in order to allow the gas contained in the powder jet 21 to escape.

The quantity of powder is next stopped by the mechanical system of valves 344 to be stored in the storage chamber 340. Below these mechanical valves 344 is found the balance 316 which makes it possible to weigh each portion of powder as shown in FIG. 11.

To initialise the system before the step of weighing on the balance 316, all the valves are opened at the same time for several seconds in the presence of a powder jet. Then, all the valves are closed at the same time. Next, the powder fills the storage tubes for a defined duration of the order of two to five minutes as a function of the adjusted flow rate.

The weighing cycle starts with the opening of a first valve 344 which frees the powder which reaches the balance 316 for a weighing. The value is recorded in a database and attached to the conduit, which corresponds to the first zone for sampling the powder jet.

A second mechanical valve 344 opens in its turn, and a second weighing is carried out. The value thus recorded corresponds to the sum of the first portion with the second portion. The difference in the two makes it possible to obtain the value specific to the second sampling portion.

This cycle is repeated as many times as there are powder separation portions. In the end, each portion of powder has been weighed, and it is thus possible to compare the quantity of powder in each portion of the powder jet. In addition, the sum of each portion makes it possible to obtain the total weight of the quantity of powder sampled during a defined time. The flow rate of powder is then obtained.

Once the cycle has finished, the powder arranged on the balance is evacuated by the suction device 348.

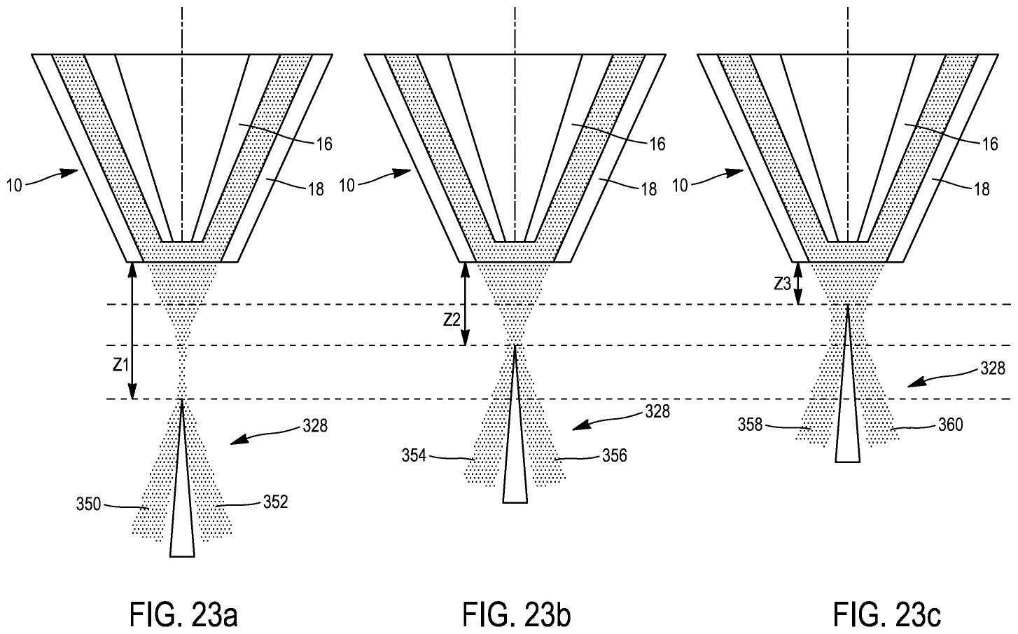

FIGS. 23a, 23b and 23c show, according to a schematic diagram, a front view of the flow of the powder jet into a separating element 328 comprising, according to another embodiment, two separation walls 10 in order to separate the initial powder jet into two powder jets. The separating element 328 is situated at different heights z with respect to the flow of the initial powder jet. In FIG. 23a, the separating element 328 is situated at a distance z1 from the nozzle 10 which brings about the formation of two portions of powder jet 350, 352. In FIG. 23b, the separating element 328 is situated at a distance z2 from the nozzle 10 which brings about the formation of two portions of powder jet 354, 356. In FIG. 23c, the separating element 328 is situated at a distance z3 from the nozzle 10 which brings about the formation of two portions of powder jet 358, 360.

Thus, the technical effect of the analysis system 310 according to the invention is notably to enable a characterisation of the powder jet as a function of different heights.

The technical effect of the analysis system 310 according to the invention is also to control the homogeneity of the powder jet in order to validate the correct centring of the cones of the nozzle. The homogeneity measurement is carried out by measuring the quantity of powder that has flowed in each conduit.

Finally, the analysis system 310 also makes it possible to determine the mass flow rate of the powder jet.

The analysis system also comprises an electronic control device (not shown) in order to control the motor making it possible to open the valves 344 and to acquire the data of the balance 316 to perform the calculations of the different weighing operations.

The assembly formed by the device for detecting the laser beam, the cone centring device and the powder jet analysis system is thus placed inside the additive manufacturing machine and only necessitates placing the deposition nozzle above the device for detecting the laser beam to start the process of detecting the laser beam. Next, the cone centring device may be used, thanks to a known distance between the centre of the cone centring device 200 and the calibrated hole 111, then the powder jet analysis system is used in its turn.

FIGS. 8, 9a, 13, 17 and 23a, 23b and 23c represent schematic diagrams and are simplified compared to the other figures representing the possible embodiments of the invention in question.

The embodiments described previously are indicated as examples uniquely.

1. Analysis system (310) for a powder jet of an additive manufacturing machine, said powder jet (21) comprising powder and gas, said analysis system (310) comprising a separation device (312), said separation device (312) comprising:
a separating element (326, 327) comprising a circular lateral wall (328) defining a cylinder and at least one separation wall (330) suited to separating the inner volume of said separating element (326, 327) into n equal portions symmetrical with respect to the axis of symmetry of the cylinder, said separating element (326, 327) being suited to receiving an initial powder jet (21) at the centre of said separating element (326, 327), on said at least one separation wall (330) in order to separate the initial powder jet (21) into n portions of powder jets;
means for detecting the quantity of powder in each portion of powder jet.

2. Analysis system (310) according to claim 1, said means for detecting the quantity of powder in each portion of powder jet comprising:
an expansion chamber (332) for separating the gas from the powder in each portion of powder jet;
a storage chamber (340) for storing the powder of each portion of powder jet;
said at least one separation wall (330), the circular wall (328) and the expansion chamber (332) forming n conduits for guiding each portion of powder jet to the storage chamber (340) suited to containing separately the quantity of powder coming from each conduit.

3. Analysis system (310) according to claim 2, the storage chamber (340) being provided with a storage tube (342) for each conduit, each storage tube (342) being connected to a valve (344) to close off the conduit.

4. Analysis system (310) according to claim 3, comprising an opening device (314) to make it possible to open the valves (344).

5. Analysis system (310) according to claim 4, the opening device (314) comprising a number n of adjustable cams (315).

6. Analysis system (310) according to one of claims 2 to 5, the expansion chamber (332) comprising a circumferential chicane (336) to allow the gas to escape.

7. Analysis system (310) according to one of claims 2 to 6, the expansion chamber (332) having a cylindrical end and the storage chamber (340) having a linear end.

8. Analysis system (310) according to one of claims 2 to 7, comprising a weighing device (316) suited to weighing the quantity of powder coming from each conduit.

9. Analysis system (310) according to claim 8, comprising a suction device (348) for sucking up the quantity of powder on the weighing device.

10. Analysis system (310) according to one of the preceding claims, the separation device (312) being produced by stereolithography.

11. Analysis method for powder jet, wherein the powder jet is emitted from the nozzle (10) of an additive manufacturing machine on an analysis system (310) according to one of claims 1 to 10, comprising the following steps:
emission of the powder jet (21) comprising powder and gas;
separation of the powder jet (21) by said at least one separation wall (330) of the separating element (326, 327) into n portions of powder jet;
detection of the quantity of powder in each portion of powder jet.
